(19) United States
(12) Patent Application Publication
(10) Pub. No.: US 2026/0228620 A1
(43) Pub. Date: Aug. 6, 2026

(54) DYNAMIC AND UNIFIED PERFORMANCE EVALUATION IN A MACHINE-LEARNING PIPELINE

(71) Applicant: Oracle International Corporation, Redwood Shores, CA (US)

(72) Inventors: Rahul Yadav, Allentown, PA (US); Ashish Pandey, Bear, DE (US); Seth Snider, Brownsburg, IN (US); Krishnadayalu Swaminathan, Santa Clara, CA (US)

(73) Assignee: Oracle International Corporation, Redwood Shores, CA (US)

(21) Appl. No.: 19/300,550

(22) Filed: Aug. 14, 2025

Related U.S. Application Data
(60) Provisional application No. 63/753,349, filed on Feb. 3, 2025.

(51) Int. Cl. G06N 20/00

(52) U.S. Cl. CPC G06N 20/00

(57) ABSTRACT

The present disclosure relates to techniques for a dynamic and unified performance evaluation of a machine-learning (ML) pipeline, incorporating a configuration of ML models, based on a unified performance metric. The techniques involve accessing data comprising a set of data samples, where each data sample corresponds to one or more data types, including images, text, audio, or structured data elements. The data may be input into the ML pipeline, including ML models combined in the specific configuration (e.g., series, parallel), with model types corresponding to classification or regression. The decision boundary of each ML model is dynamically adjusted by evaluating relevant evaluation metrics. The ML pipeline may process data to generate a result based on the adjusted decision boundaries. The unified performance metric may be generated dynamically based on the model types, configuration, and their respective contributions. The result is evaluated based on the unified performance metric satisfying performance criteria.

### CROSS-REFERENCE TO RELATED APPLICATIONS

This application claims the benefit of and the priority to U.S. Provisional Patent Application No. 63/753,349, filed on Feb. 3, 2025, which is hereby incorporated by reference in its entirety for all purposes.

### BACKGROUND

Machine-learning (ML) pipelines contribute to various real-world applications leveraging decision-making, such as healthcare diagnostics, financial forecasting, and autonomous systems. These ML pipelines often involve a combination of classification models, regression models or a combination thereof, where a configuration of these models may influence the overall performance. For example, in medical diagnosis, a classification model may predict a presence or absence of a disease, while a regression model may estimate a severity (e.g., percentage) or progression (e.g., number of months or years until progression) of the disease. Similarly, an output of a regression model may also be affected by an output of a classification model, for example, an ML pipeline predicting a timeline of a project (e.g., days, weeks, or months), where a classification model may predict a likelihood of a specific event (e.g., resource availability or completion milestone).

However, assessing the performance of such ML pipelines particularly that follows a sequential configuration may present significant challenges. The sequential nature of these models may enable nuanced decision-making, but accurate evaluation of combined model performance may be a concern for reliable predictions on unseen data. Typically, evaluation metrics are designed for standalone ML models, which may fail to capture the interdependencies between classification and regression models for a given configuration. For instance, the classification model with incorrect prediction or lower classification performance may propagate errors thereby impacting a subsequent regression stage, resulting in degraded overall outcomes. Furthermore, it may be difficult to perform comparison for different model combinations effectively accounting for both classification accuracies and/or regression errors.

Additionally, traditional performance metrics used to evaluate machine-learning models are often static and may not adapt to the changing nature of model types or model interactions (or configurations). In ML pipelines, where multiple models such as classification and regression models are combined in different configurations, static metrics may not accurately assess the overall performance. Since these metrics do not account for the interdependencies between ML models, misleading evaluations may be generated that may lead to suboptimal assessments and poor decision-making.

### SUMMARY

Certain aspects of the present disclosure relate to techniques for a dynamic and unified evaluation of a machine-learning pipeline, incorporating a configuration of machine-learning (ML) models, based on a unified performance metric. With dynamic evaluation, the unified performance metric may adapt itself to different model types (e.g., classification and/or regression) and to a specific configuration in which the models are configured within the ML pipeline. The machine-learning models may include classification models, regression models or a combination thereof, where the configuration may correspond to a parallel or a series combination. The disclosed techniques may include accessing data e.g., including a set of data samples that may correspond to one or more data types e.g., an image, a text, an audio, and/or a set of data elements (e.g., structured quantitative data). The data may be input to the ML pipeline, including e.g., a first ML model and a second ML model, as seed models, to perform inference on the (unseen) data, by processing the data in the specific configuration, thereby generating predictions.

For example, in an e-commerce recommendation system, a first ML model may include a regression model that predicts an estimated price of a product based on an image and/or text (e.g., product image and/or product description). This ML model may predict a price of a product based on its visual features or textual descriptions, such as brand, quality, or category. The second ML model may include a classification model that predicts whether a customer is likely to make a purchase, based on the predicted price and additional features or the set of data elements such as customer behavior, past purchases, or preferences. The configuration of these two models may comprise a series combination, where the output of the first model (predicted price) is fed into the second model, which predicts the likelihood of a purchase. Alternatively, the configuration may comprise a parallel combination, where both ML models may independently predict their respective outcomes (price and purchase likelihood).

For each machine-learning model in the ML pipeline, a decision boundary may be dynamically adjusted by evaluating one or more evaluation metrics associated with each ML model of the ML pipeline based on characteristics of the data such as distribution, variance, or class imbalances. For example, if the data has a skewed distribution where values are majorly concentrated at one end, the decision boundary may be adjusted to account for this skew, making the model better at predicting the tail-end values. It may be understood that each machine-learning model in the ML pipeline is already trained, and the adjustment to the decision boundaries may be performed as post-processing, where the outputs associated with each ML model are refined rather than retraining the ML model itself.

In some examples, the dynamic adjustment of the decision boundaries may include automatically calibrating predicted outputs of the ML models. For example, in classification, the calibration may involve refining the predicted probabilities using techniques e.g., logistic regression to calibrate the probabilities, enabling better alignment with the true class labels. In regression, the decision boundary may be adjusted by calibrating the predicted continuous values using methods such as logistic regression (to model the relationship between predictions and actual outcomes) or quantile regression that may reduce errors such as mean absolute percentage error (MAPE), or root mean squared error (RMSE) so that the predictions align more accurately with the true values.

Based on the dynamic adjustment in decision boundaries, the machine-learning pipeline may process the data generating a result. The ML pipeline may be evaluated by a unified performance metric by calculating its corresponding value to determine whether the unified performance metric satisfies a first predefined criterion or the second predefined criterion. The first predefined criterion may correspond to the unified performance metric exceeding a specified threshold, while the second predefined criterion may correspond to the unified performance metric falling below the specified threshold. This threshold may either be defined by a user based on domain expertise or predicted using a computational technique, such as machine-learning algorithms that analyze historical data to determine the threshold for model. In some examples, when the value of the unified performance metric corresponds to the first performance criterion, the generated result may be output, and the seed models may be leveraged for further inference on new data.

In some aspects of the present disclosure, the unified performance metric for the machine-learning pipeline may be generated dynamically based on the configuration (e.g., series or parallel) in which the ML models are configured within the ML pipeline and respective model types (e.g., classification or regression). The unified performance metric may include a statistical weighted average of a first evaluation metric associated with the first ML model and a second evaluation metric associated with the second ML model. Both evaluation metrics may correspond to the respective model types, for example, if the model types of the first ML model and the second ML model are classification and regression, respectively, the first evaluation metric may correspond to accuracy, F1 score, or Mathews correlation coefficient (MCC) and the second evaluation metric may correspond to MAPE, or RMSE. Moreover, these evaluation metrics may either be similar or different than the one or more evaluation metrics used for adjusting decision boundaries. The unified performance metric may include weights for each ML model that may correspond to a product of a contribution of the ML model to the ML pipeline and a penalty factor that may be adjusted based on the configuration. Additionally, each evaluation metric may be normalized to enable consistency across different evaluation metrics for the ML models.

In some other examples, if the unified performance metric falls below the specified threshold, the retraining of the seed models included in the ML pipeline may be triggered. The retraining may include iteratively fine-tuning the seed models based on custom training data that may be of the same or similar data types used for inference of the seed models. In certain instances, the custom training data may be limited, therefore, augmentation techniques may be applied to expand the dataset and introduce variations in the training examples. The choice of augmentation method may depend on the data type, for example, for set of data elements (or continuous data), techniques such as SMOTE (synthetic minority over-sampling technique) or VAE (variational autoencoders) may be used, while for image or audio data, linear transformations e.g., rotation, noise addition or other domain-specific methods may be employed.

The iterative fine-tuning of the seed models may involve a parameter-tuning by defining a set of hyperparameters (e.g., number of layers, depth of a tree, and/or learning rate), where each hyperparameter is assigned a range of values. The parameter-tuning may assist to find a combination of hyperparameters in a search space (e.g., by leveraging grid search or random search) that improves the unified performance metric. Alternatively, the parameter-tuning may be performed by modeling the unified performance metric as a probabilistic function and using it to guide the search process for suitable hyperparameters. It may use a Gaussian process (GP) to predict performance of unseen hyperparameters combinations based on previous evaluations.

During each iteration, a retrained or fine-tuned version of the seed models may be stored in a model buffer for further processing e.g., performing inference on the (unseen) data based on the unified performance metric. Once the ML pipeline including the seed models has been retrained, inferences on new data or unseen data may be performed by retrieving the retrained seed models from the model buffer.

In some examples, the first machine-learning model may comprise a classification model and the second machine-learning model may comprise a regression model. It is to be understood that the order of the machine-learning models in the sequential model may vary.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure is described in conjunction with the appended figures:

FIG. 1 is an illustrative example of a machine-learning pipeline including a classification model and a regression model.

FIG. 2 shows an example illustration of multiple combinations of classification and regression models.

FIG. 3 shows an example illustration of how a decision boundary may affect the performance of the classification model.

FIG. 4 illustrates an exemplary workflow for evaluating and retraining the machine-learning pipeline, based on a unified performance metric.

FIG. 5 shows an illustrative example highlighting an impact of an imbalanced dataset on one or more evaluation metrics associated with the classification model.

FIG. 6 shows an exemplary three-dimensional (3D) plot depicting a relationship between a classification performance metric, a regression performance metric and a unified performance metric that combines these two metrics into a single evaluation metric.

FIG. 7 illustrates a set of heatmaps representing Mathew correlation coefficient (MCC) and accuracy under varying conditions of class distributions and different error rates.

FIG. 8 illustrates an exemplary workflow for a dynamic and unified performance evaluation of the machine-learning pipeline in accordance with certain aspects of the present disclosure.

FIG. 9 depicts a simplified diagram of a distributed system through which user inputs can be made in accordance with some aspects of the present disclosure.

FIG. 10 illustrates various components of a cloud infrastructure system.

FIG. 11 illustrates an exemplary computer system that may be used to implement certain aspects of the disclosed techniques.

### DETAILED DESCRIPTION

Some embodiments of the present disclosure relate to techniques for a dynamic evaluation of a machine-learning (ML) pipeline that includes a configuration of machine-learning models based on a unified performance metric. The dynamic evaluation may be performed, such that the unified performance metric is adapted in accordance with the configuration and machine-learning model types (e.g., classification or regression). In some examples, the configuration includes a series or a parallel combination of multiple machine-learning models comprising classification models, regression models or a combination thereof. These ML models may be pre-trained models (such as transfer-learning based models) that may serve as seed models to perform inference on (unseen) data, thereby enabling time efficiency and lower operational costs. To perform inference, the disclosed techniques may include accessing the data that comprises a set of data samples that may correspond to one or more data types such as an image, a text, an audio or a set of data elements such as continuous data or an observation including features or structured data.

For example, in an image-based ML pipeline predicting a success of a marketing campaign, a first classification model may analyze the images of advertisements or product promotions (e.g., visual design, colors, or emotions depicted) to predict whether the campaign will be successful (e.g., corresponding to a binary outcome). The second classification model may then use the output of the first model to predict more specific details, such as types of customers that are most likely to engage with the campaign based on the predicted success. Alternatively, a regression model may be configured in series to predict an estimated revenue or return on investment (ROI) based on the output of the first model, which predicts campaign success. In other examples, the regression model may be configured in parallel, predicting the estimated revenue generated by the campaign, regardless of the output of the classification model. For this example, a data sample may include, e.g., an image and the set of data elements (or additional features) such as campaign budget, customer demographics, customer engagement metrics e.g., conversion rates or click-through rates.

In machine-learning pipelines involving multiple ML models, selecting a combination of models to effectively perform a task may be challenging, particularly when different model types such as classification models and regression models are involved within the same pipeline. Each model type typically corresponds to distinct evaluation metrics, e.g., for classification tasks, metrics such as F1-score, Matthews correlation coefficient (MCC), and accuracy are commonly used, while for regression tasks, metrics such as root mean squared error (RMSE) and mean absolute percentage error (MAPE) are more relevant. Due to these differences in evaluation metrics, achieving a unified evaluation of the entire ML pipeline can be difficult. For instance, a customer (or a client) may express interest in a combination of pre-trained “seed” models for classification, regression, or a combination thereof, which have been trained on broad (or generalized) datasets. These seed models may be applied to new, unseen datasets for inference. However, due to the differences in evaluation metrics used for classification and regression, as well as variations in configurations (e.g., ML models configured in series or parallel), determining the suitability of a specific model combination may be a concern.

For example, the first model in the ML pipeline may have an average performance for an evaluation metric, such as a classification model achieving 70-80% accuracy, while the second model-a regression model—may show excellent independent performance, with an RMSE of 0 and/or a MAPE of 0%. Although both models perform well in isolation, combining these in a ML pipeline can present challenges, as their evaluation metrics (classification vs. regression) are not directly comparable. Additionally, when configured in series—where the output of the first model serves as input for the second-errors from the first model may propagate, impacting overall performance. To illustrate, if the classification model with 70% accuracy, and the regression model with perfect performance are combined on a percentage basis, then averaging the two (e.g., (70+100)/2=85%) may suggest a good overall performance. However, this can be misleading, as the second model works with suboptimal input from the first, which can degrade the final output. The error from the first model may propagate through the ML pipeline, reducing the overall effectiveness. This highlights the difficulty of evaluating model combinations, particularly when performance levels vary across different ML models configured within the ML pipeline.

Therefore, a unified performance metric may be dynamically generated to aggregate the evaluations of various ML models, enabling a fair and unified comparison of different model combinations within the ML pipeline. The unified performance metric may be adaptively configured based on the configuration (e.g., parallel or series) in which different ML models are combined within the machine-learning pipeline, the model type of each ML model, and their respective contributions. This aggregated metric may enable practitioners and customers to fairly rank and compare pipelines, considering various configurations (e.g., parallel or series) across categorical and/or continuous evaluation metrices. The unified performance metric for a machine-learning pipeline including a pair of ML models may be defined as a weighted average of a normalized first evaluation metric associated with the first machine-learning model (X) and a normalized second evaluation metric associated with the second machine-learning model (Y). The unified performance metric (Unified_{PM}) may be calculated as,

$${Unified}_{PM} = \frac{{w}_{1} X + {w}_{2} Y}{2} ,$$

where weights w₁ and w₂ may be adjusted dynamically based on a penalty factor that corresponds to the configuration and/or significance of each model to the machine-learning pipeline.

For example, if the first machine-learning model—classification model with the first evaluation metric e.g., Mathews correlation coefficient (MCC) is configured with the second machine-learning model—regression model with the second evaluation metric e.g., mean absolute percentage error (MAPE), the unified performance metric may be calculated as,

$${Unified}_{P M} = \frac{{w}_{1} \frac{( MCC + 1 )}{2} + {w}_{2} {e}^{- MAPE}}{2} .$$

The evaluation metrics, i.e., MAPE and MCC are normalized by

$${e}^{- M A P E} and \frac{( M C C + 1 )}{2} ,$$

respectively, where MAPE and MCC originally ranging from 0 to 100 and −1 to 1, respectively, are both now ranging from 0 to 1 for consistent comparability across different ML models. Here, the weights may be represented as, w₁=α₁μ₁ and w₂=α₂μ₂, where a corresponds to the contribution and μ corresponds to the penalty factor that depends on the configuration. For the cascade configuration, when the regression is based on classification, the penalizing factor μ₁ for the first ML model may be set to 1 and α₁ to e.g., 0 to 1 (based on contribution), while the regression may be penalized by w₂=α₂(MCC+1)/2, propagating a classification error. Similarly, for parallel configuration μ₁,μ₂ may be equal to 1 and weights ai, α₂ may be based on the contribution of each model to the ML pipeline. Alternatively, if the classification is based on regression, the unified performance metric may be written as,

$${Unified}_{P M} = \frac{{e}^{- M A P E} + {e}^{- M A P E} M C C}{2} .$$

Although various aspects of present disclosure are described with respect to a pair of machine-learning models, it will be understood by those skilled in the art that the techniques disclosed herein are not limited to this specific number of ML models. Rather, the techniques and approaches outlined may be equally applicable to evaluation of the ML pipeline including two or more ML models. For example, the unified performance metric may be written for N machine-learning models included in the ML pipeline as,

$${Unified}_{P M} = \frac{{\sum }_{i = 1}^{N} {w}_{i} {X}_{i}}{N} ,$$

where Xᵢ corresponds to the evaluation metric with each model and wᵢ corresponds to a product of the contribution of each model to the ML pipeline and the penalizing factor that depends on the configuration i.e., parallel or series.

In some aspects, the evaluation techniques including the unified performance metric may be leveraged to select the best-performing model combinations from multiple available seed models for unseen data. The ML pipeline, comprising combinations of various ML models or seed models, may correspond to pre-trained models selected based on prior inference results and/or the corresponding unified performance metric. These seed models may be used to generate predictions on unseen data, which are then evaluated by the unified performance metric, accounting for various types of classification and regression outputs. For each combination (or instance), it may be determined whether the unified performance metric satisfies a predefined criterion that may include a specific threshold value. If the value of the unified performance metric for a given ML pipeline meets or exceeds the specified threshold, the seed models within the ML pipeline may be leveraged to infer results on a batch of new data. However, if the unified performance metric falls below the specified threshold, a retraining phase may be triggered, which fine-tunes the seed models using custom training data through parameter-tuning, data augmentation, and/or model interpretation.

For the machine-learning models, decision boundaries may be dynamically adjusted based on one or more evaluation metrics associated with the models. For example, in a classification context, the decision boundary may be automatically adjusted by evaluating ROC (receiver operating characteristic) curves or precision-recall curves, with adjustments based on one or more evaluation metrics such as the F-1 score, or MCC. Alternatively, the decision boundaries may be calibrated automatically by adjusting predicted probabilities for the classification model or by adjusting continuous values for the regression model. In classification, calibration may involve refining the predicted probabilities using techniques such as Platt scaling, isotonic regression, or by applying logistic regression, enabling better alignment with the true class labels. In regression, the decision boundary may be adjusted by calibrating the predicted continuous values using methods such as quantile regression or logistic regression (to model relationships between predictions and actual outcomes), aimed at reducing errors such as MAPE or RMSE so that the predictions align more accurately with the true values.

Based on the dynamic adjustment of decision boundaries, the machine learning (ML) pipeline processes the data and generates results. The performance of the ML pipeline may be assessed by calculating a value of the dynamically generated unified performance metric, which is estimated to assess whether it meets one of two predefined performance criteria. The first performance criterion is met if the unified performance metric exceeds a predefined threshold, indicating satisfactory performance for the task at hand. The second performance criterion is satisfied if the unified performance metric falls below this threshold, suggesting that improvements are needed. If the performance metric aligns with the first criterion, the results are displayed, and the seed models within the pipeline may be leveraged for further inference on new, unseen data.

In certain examples, where the unified performance metric falls below the specified threshold, retraining of the seed models in the pipeline may be initiated. This retraining process may involve iteratively fine-tuning the ML models using custom training data with similar data types of data samples used for inference. As custom training data may be limited, data augmentation techniques are commonly applied to artificially expand the dataset and introduce additional variations in the training samples, thereby improving model robustness. The choice of augmentation technique may depend on the data type e.g., for continuous data or structured data, methods such as SMOTE (synthetic minority over-sampling technique) or VAE (variational autoencoders) may be used, while for image or audio data, typical augmentations may include rotation, noise addition, or other domain-specific transformations.

The iterative fine-tuning of the models may also involve hyperparameter tuning, where a set of hyperparameters-such as the number of layers in a neural network, tree depth in decision trees, or learning rate in optimization algorithms—are defined and explored. Each hyperparameter may be assigned a range of possible values, and the objective may be to identify the combination that improves the value of the unified performance metric. Common methods for this search may include grid search or random search. In some examples, the parameter-tuning process may be enhanced by modeling the unified performance metric as a probabilistic function, which helps guide the search for suitable hyperparameters. For instance, a Gaussian Process (GP) may be used to predict the performance of unseen combinations of hyperparameters, based on prior evaluations, which reduces the computational cost of searching large hyperparameter spaces.

After each iteration, the retrained or fine-tuned versions of the seed models may be stored in a model buffer for further processing or evaluation. This buffer may enable efficient retrieval and reuse of the retrained seed models that have undergone fine-tuning, facilitating faster inference on new or unseen data. Once the retraining process is complete and the models are finetuned, the ML pipeline may perform inference on new data by retrieving the updated seed models from the model buffer. This approach may assist in making the ML pipeline flexible, adaptive, and continuously improving its ability to make accurate predictions on real-world data.

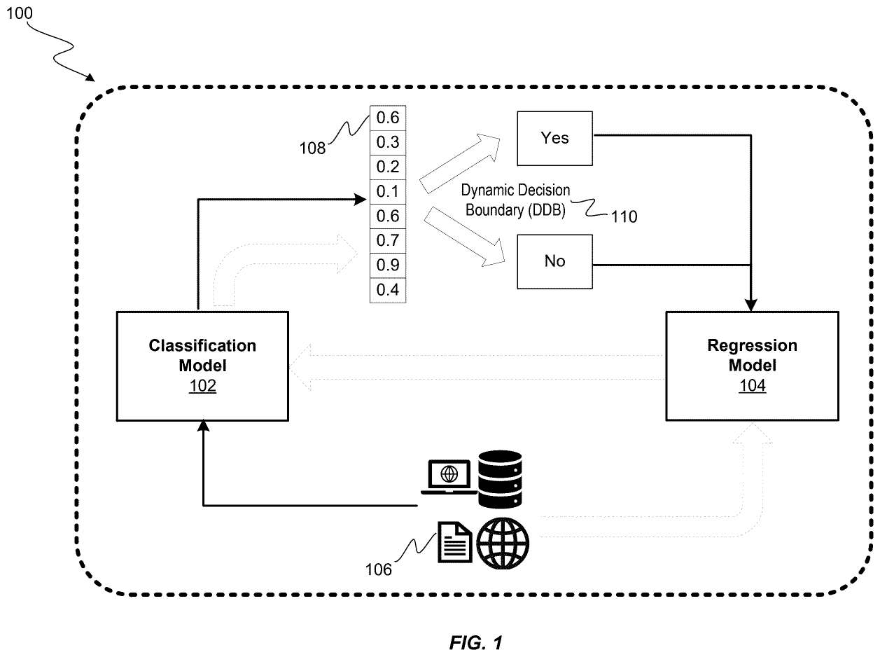

In various machine-learning applications, downstream tasks may include both categorical and continuous outcomes to solve complex problems. Such tasks may involve machine-learning (ML) pipelines where models operate in parallel or in sequence (e.g., when an output of one model serves as an input or condition to another). For example, FIG. 1 shows an illustration of an ML pipeline 100 including a classification model 102 to determine a preliminary result, followed by a regression model 104 providing a granular prediction based on the preliminary result corresponding to classification. While the illustrated ML pipeline 100 demonstrates two ML models i.e., the classification model 102 configured in series with the regression model 104, it may be understood that a number, the configuration and the sequential order of these ML models may vary i.e., one or more regression models 104 connected in series or in parallel combination may operate first followed by the classification model 102 (as shown by dotted lines). The choice of the number and the configuration (e.g., parallel or series) may depend on the nature of the task, targeted outcomes, and/or data structure. Additionally, the model types may also vary, withs both models potentially being either classification models or regression models.

For the ML pipeline 100, shown in FIG. 1, data may be collected from various sources such as databases, file storage systems, web-based data streams, comprising a dataset 106. This dataset 106 may be ingested by a machine-learning model such as the classification model 102 that performs an initial classification task. The classification model 102 may output a set of confidence scores 108 or probability against each data sample of the dataset 106 corresponding to a set of class labels, representing a certainty of the classification model 102 in predicting each class. The confidence scores 108 may then be labeled based on a dynamic decision boundary 110 that involves a threshold mechanism, introducing a decision-making that may impact output of the classification model 102 and hence the subsequent processing of the ML pipeline 100. This decision-boundary may be user-defined or dynamically adjusted based on a computation technique (such as a regression technique). Similarly, the decision boundary of the repression model 104 may be dynamically adjusted e.g., by calibrating the output values to actual values using techniques such as logistic regression. Once the decision boundaries have been adjusted for each ML model, the regression model 104 may process classification outputs to generate a continuous output. For example, in the context of project management, if the classification model determines that a project is delayed, the regression model 104 may further process this output to predict an approximated duration of the delay e.g., in minutes, days, or years. In some examples, if the classification score fails to meet the threshold condition, the regression model may be bypassed.

The sequential integration of classification and regression models may introduce a significant challenge when attempting to evaluate performance of such pipelines holistically, as classification and regression models are traditionally assessed using different types of evaluation metrics. Typically, classification tasks are assessed by discrete evaluation metrics such as F1 scores, accuracy, or Mathews correlation coefficient (MCC), which measures the ability of the model to assign inputs to specific categories. In contrast, regression models 104 are assessed using continuous evaluation metrics such as mean squared error (MSE), root MSE (RMSE), or mean absolute percentage error (MAPE), which quantify an error in predicting continuous outputs. Utilizing separate evaluation metrics for classification and regression may make it difficult to measure the performance of the ML pipeline 100 as a whole, particularly when two tasks are interdependent.

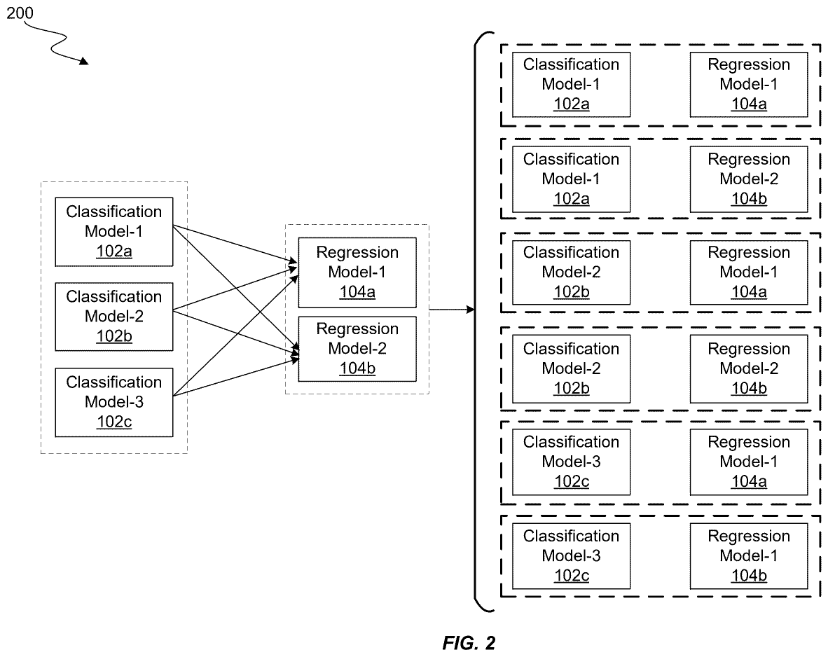

In the ML pipeline 100, particularly involving sequential models, it may be difficult to determine which combination of models will perform best among an available set of ML models for achieving targeted or overall performance. FIG. 2 shows an example illustration 200 of multiple combinations of classification models and regression models, where outputs from classification models (e.g., Classification Model-1 102a, Classification Model-2 102b and Classification Model-3 102c) are fed into corresponding regression models (e.g., Regression Model-1 104a, Regression Model-2 104b). The combination of classification and regression models within each ML pipeline highlights the complexity to a joint performance evaluation, as different model pairings can lead to varying levels of performance and effectiveness based on how well the models complement each other in addressing the task at hand.

Each combination may produce distinct evaluation metrics for classification (e.g., F1-score, MCC or accuracy) and regression (e.g., RMSE or MAPE). In one example, for selecting a combination of ML models in an ML pipeline to effectively perform a specific task, a set of pre-trained—seed models for classification and regression may be provided. These seed models, which are generic models trained on a broad (or generalized) dataset, may be applied to unseen datasets to derive inferences. However, due to a difference in evaluation metrics used for classification and regression, it may become difficult to determine which combination of models will perform best for the specific task. For example, Classification Model-1 102a paired with Regression Model-1104a may yield a high classification score (e.g., accuracy or MCC), indicating strong categorical prediction.

However, a corresponding regression performance may suffer, producing a higher value of regression (error) metrics e.g., MAPE of 30%. This may raise a problem of evaluating and comparing such model combinations objectively, particularly when trade-offs may exist between performance associated with classification and regression. Therefore, a unified evaluation metric may be defined dynamically for aggregating the classification and regression evaluation metrics to compare performance of each pair of combinations in respective ML pipelines. Such an aggregated evaluation metric may enable practitioners and customers to systematically compare and rank all given ML pipelines fairly, accounting for both discrete and continuous accuracy.

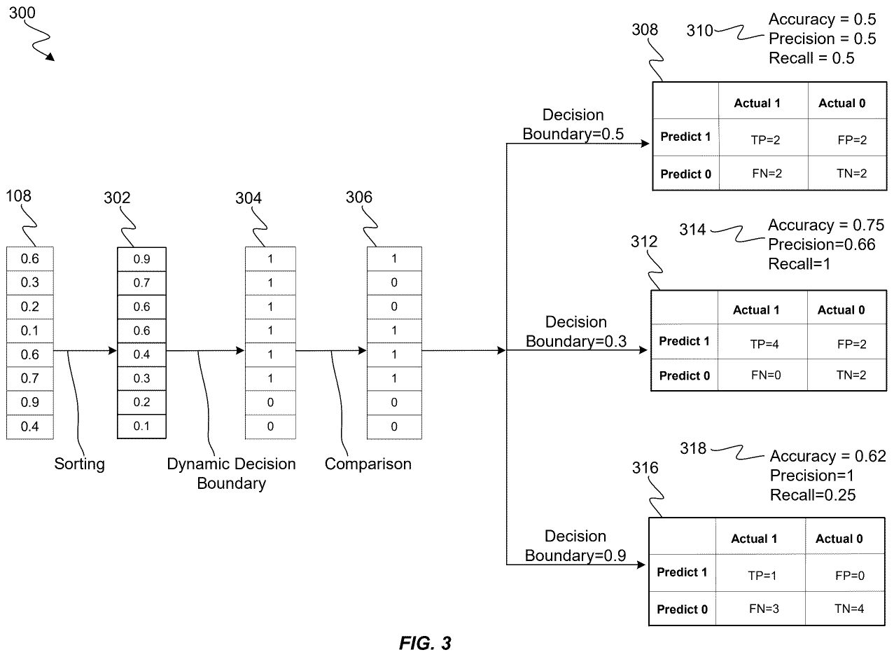

FIG. 3 illustrates how a decision boundary influences the performance of the classification model 102. The decision boundary may be manually set by the user or dynamically adjusted using techniques described hereafter. For example, a seed model representing the classification model may have a default boundary of 0.5 that may be adjusted during training (e.g., from 0.6 to 0.7) based on business needs, such as detecting fraud. The decision boundary may help control model sensitivity, balancing false positives and negatives. The classification model 102 may predict a class of a data element by determining probabilities for each data element. In one example, a set of eight probabilities is output for the elements fed to the classification model, each representing a probability corresponding to a data element. These probabilities may then be organized into a structured set.

Once the probabilities are organized, the decision boundary may be applied to determine predicted labels. For example, with a decision boundary set at 0.3, elements with probabilities above this threshold are labeled ‘1’ and those below ‘0’. This transforms the set of probabilities into a predicted set of labels, which in this example may result in six ‘1’ labels and two ‘0’ labels. The predicted labels may be compared with the actual labels to evaluate the performance using a confusion matrix and evaluation metrics such as accuracy, recall, MCC and precision may be calculated based on the results.

Changing the decision boundary alters the entries in the confusion matrix and the evaluation metrics. For instance, reducing the boundary to 0.3 increases true positives and reduces false negatives, thus improving performance. A boundary set too high (e.g., 0.9) could cause overfitting, increasing false negatives and affecting accuracy. Evaluation metrics are recalculated based on these adjustments. Visualization tools such as Python's Plotly or MATLAB can be used to graph evaluation metrics, providing insight into the model's performance, and helping optimize the decision boundary.

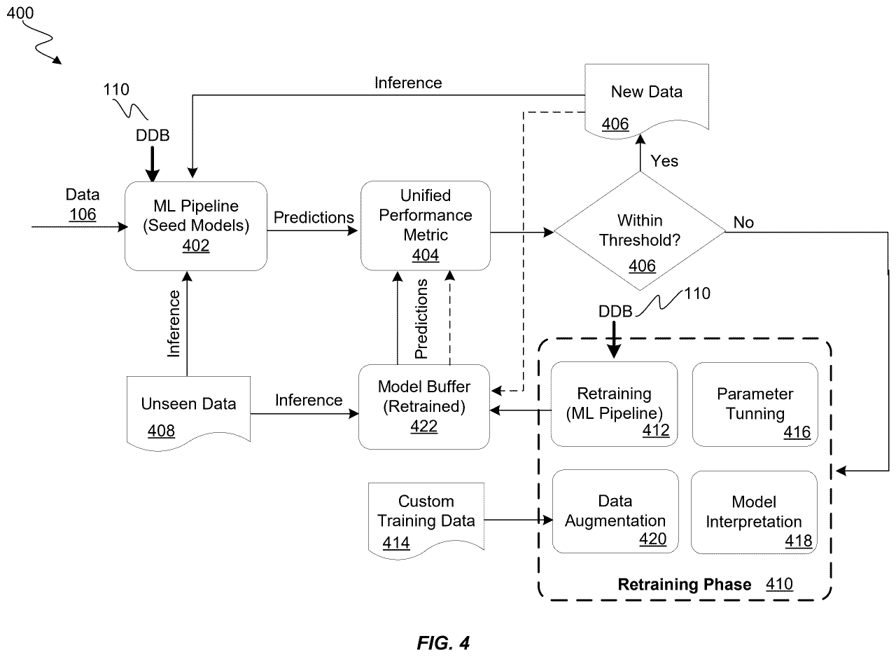

FIG. 4 illustrates an exemplary workflow 400 for dynamic and unified evaluation and retraining of a machine-learning pipeline, including seed models 402, based on a unified performance metric 404. The identifier for the ML pipeline 100 in FIG. 1 may refer to a same or a different ML pipeline, including the seed models 402 in FIG. 4. The exemplary workflow 400 may address the problem of identifying best-performing model combinations from an available set of ML models for unseen data 408. The seed models 402, comprising a combination of the classification models 102, regression models 104 or a combination thereof, may refer to pre-trained models that may be selected based on prior inference results and/or corresponding unified performance metric 404. The ML pipeline or the seed models 402 may be used to generate predictions on unseen data 408, which may be further evaluated by the unified performance metric 404 accounting for various types of classification and regression outputs. At 406, it may be determined whether the performance of each seed model 402 satisfies predefined performance criteria (e.g., including a specified threshold) based on the unified performance metric 404. If the unified performance metric 404 exceeds or meets the specified threshold, the seed models 402 may be used for further inferences on a batch of new data 406. Upon failing the performance criteria, retraining phase 410 may be triggered that may fine-tune the seed models 402 on custom training data 412 through parameter-tuning 416, data augmentation 420 and/or model interpretation 418.

The dynamic decision boundary (DDB) 110 for the seed models 402 may be predefined or dynamically set during an initial evaluation of the seed models 402. The dynamic decision boundary 110 may refer to an ability of the ML models to adjust a threshold that determines how decisions are made regarding the predictions, whether class labels in classification tasks or continuous values in regression tasks. This threshold may be adjusted based on one or more evaluation metrics or performance criteria. Once the seed models are trained, dynamically adjusting the decision boundary may significantly enhance performance by tailoring the threshold used for predictions. This adjustment may be particularly valuable when improving specific performance metrics, such as increasing the true positive rate (TPR) or reducing the false positive rate (FPR) in classification, or reducing prediction errors (e.g., mean squared error) in regression. Tools such as ROC curves, precision-recall curves, or error metrics may be used to guide the adjustment. By analyzing these curves, DDB 110 may be selected that strikes the best balance between precision, recall, MCC or any other relevant metric, depending on task at hand. For instance, for a medical diagnostic, the DDB 110 may be lowered to prioritize detecting as many positive cases (disease diagnoses) as possible, even if it leads to more false positives, while in a fraud detection system, the DDB 110 may be raised to reduce false positives, even if it means some fraud cases are missed.

In some other examples, DDB 110 may be adjusted by fine-tuning the decision boundary associated with each model using calibration methods. Calibration techniques, such as Platt scaling, isotonic regression, or quantile regression, may be used to adjust the predicted outcomes generated by either classification or regression models. Calibration may be performed independently of the initial model training and may involve the use of a separate dataset (e.g., a validation set, or a separate calibration set) to fine-tune the predicted outcomes. Once each model's predictions have been calibrated based on a targeted performance metric, such as precision, RMSE, MAPE, recall, MCC, or cost, it may result in dynamic adjustment of DDB 110. For example, in Platt scaling, a logistic regression model is applied to the output probabilities of the classification model 102, rescaling the predicted probabilities. In isotonic regression, a piecewise constant function maps the predicted values to calibrated outputs, and for regression models, techniques such as quantile regression can adjust continuous outputs to better align with actual data.

In some aspects of the present disclosure, a value of the unified performance metric for the machine-learning (ML) pipeline is calculated through statistical analysis, combining the evaluation metrics from different models in the pipeline. Specifically, this includes a statistical average of a normalized first evaluation metric (X) from the first machine-learning model and a normalized second evaluation metric (Y) from the second machine-learning model. The unified performance metric (Unified_{PM}) may then be calculated as:

$${Unified}_{P M} = \frac{{w}_{1} X + {w}_{2} Y}{2} ,$$

where the weights w₁ and w₂ may correspond to a product of respective penalty factor that corresponds to the configuration and respective contribution of each ML model in the ML pipeline. These weights may vary depending on whether the configuration of the models are in series or parallel and on the contribution of each model to the overall task.

For example, if the first machine-learning model—classification model with the first evaluation metric e.g., Mathews correlation coefficient (MCC) is configured with the second machine-learning model—regression model with the second evaluation metric e.g., mean absolute percentage error (MAPE), the unified performance metric may be calculated as,

$${Unified}_{P M} = \frac{{w}_{1} \frac{( MCC + 1 )}{2} + {w}_{2} {e}^{- MAPE}}{2} .$$

Here, the weight w₁=α₁μ₁ and w₂=α₂μ₂, where α corresponds to the contribution and μ corresponds to the penalizing factor that depends on the configuration. For the cascade configuration, when the regression is based on classification, the penalizing factor μ₁ for the first ML model may be set to 1 and α₁ to e.g., 0 to 1 (based on contribution), while the regression may be penalized by w₂=α₂(MCC+1)/2, propagating a classification error. Similarly, for parallel configuration μ₁,μ₂ may be equal to 1 and weights α₁, α₂ may be based on the contribution of each model to the ML pipeline. Alternatively, if the classification is based on regression, the unified performance metric may be written as,

$${Unified}_{P M} = \frac{{e}^{- M A P E} + {e}^{- M A P E} M C C}{2} .$$

Additionally, the normalization of the MCC metric may be done by the transformation

$$\frac{( M C C + 1 )}{2} ,$$

which maps the MCC values (ranging from −1 to 1) to a scale of 0 to 1. This normalization may enable consistency in the range of evaluation metrics, making them comparable across different models and tasks. The exponential term e^{-MAPE} may be used for the MAPE metric to compress larger error values, where smaller errors (i.e., more accurate predictions) may lead to larger values of the performance metric. In some examples, the penalty factor for the second machine-learning model may be adjusted to propagate the error by penalizing the evaluation matric associated with the second machine-learning model with a confidence score of the first machine-learning model or the first evaluation metric. For instance, for the ML pipeline including a classification model followed by a regression model, w₂ may be set to a confidence score that the classification model has on its prediction or by

$$\frac{( M C C + 1 )}{2} ,$$

reflecting how classification errors influence the performance of the regression model. This may help to account for the compounded effect of classification errors on the predictions of the regression model 104.

In contrast, in a parallel configuration, where the classification and regression models operate independently, both weights (μ₁) and (μ₂) are typically set to 1 or adjusted based on the relative importance or contribution of each model to the overall pipeline. For example, if the classification model is considered to have more influence on the task, μ₁ may be assigned a higher weight than μ₂. In other examples, if the classification model is based on regression (i.e., the regression output influences the classification), the unified performance metric can be expressed as:

$${Unified}_{P M} = \frac{{w}_{1} {e}^{- MAPE} + {α}_{2} {e}^{- MAPE} MCC}{2} .$$

This adjustment to the unified performance metric 404 may reflect the dependency of classification on regression. If both the first and second models are same i.e., classification models or regression models, their respective evaluation metrics (e.g., Matthews correlation coefficient (MCC) for both models) may be combined to form the unified performance metric. For example, for two regression models, the unified performance metric can be expressed as:

$${Unified}_{P M} = \frac{{w}_{1} {e}^{- M A P E} + {w}_{2} {e}^{- M A P E}}{2} ,$$

where weights, contributions or penalizing factors may be adjusted in accordance with the configuration of these models.

The goal of parameter-tuning 416 may be to find a combination of hyperparameters that enhance accuracy, efficiency and robustness of each seed model 402. The parameter-tuning 416 may be performed by defining a set of hyperparameters, where each hyperparameter of the set of hyperparameters includes a range of values. For example, the set of hyperparameters to tune may include, but not limited to, a batch size (e.g., values ranging as, [8, 16, 32, 64]), a learning rate (e.g., [0.001, 0.01, 0.1]), a number of neurons at each layer or a number of layers in neural network-based models (e.g., [64, 128, 256] neurons or [2, 3, 4] layers), depth of a tree for decision tree-based models (e.g., [5, 10, 20] levels). Each combination of these hyperparameters may be used to train and evaluate each seed model 402 during the retraining phase 410, enabling the identification of a suitable configuration that yields enhanced performance. While selecting various combinations, an exhaustive search (grid search) or a random search may be performed over a specified parameter grid to find the suitable configuration.

In some other examples, parameter-tuning 416 may be performed by modeling the unified performance metric (Unified_{PM}) 404 as a probabilistic function of hyperparameters, denoted by θ and using it to guide the search for suitable hyperparameters. Typically, a Gaussian process (GP)—a non-parametric model may be leveraged to model the relationship between the set of hyperparameters θ and the unified performance metric 404. The distribution of unified performance metric given the set of hyper parameters may be predicted by,

$${Unified}_{P M} ( θ ) = \frac{{w}_{1} X ( θ ) + {w}_{2} Y ( θ )}{2} + ϵ ( θ ) ,$$

where X(θ) and Y(θ) refers to the first evaluation metric and second evaluation metric, respectively, as functions of hyperparameters. The parameter ϵ(θ) may denote noise or uncertainty in the unified performance metric 404 due to factors such as limited data or model variability. This noise parameter is typically considered to be Gaussian noise with a mean of zero and variance i.e., ϵ(θ)~ [symbol] (0,σ²)

The Gaussian process (GP) works by learning from previous evaluations (hyperparameter settings and corresponding performance) and using this information to predict the likely performance of other hyperparameter settings that have not been tested (or assessed). The Gaussian process may provide not only a prediction of performance but also an estimate of the uncertainty or confidence in that prediction. This is useful in guiding the search process for optimal hyperparameters because the GP can identify areas of the hyperparameter space where further exploration is most likely to yield improvements, rather than assessing every combination of hyperparameters (as in grid or random search). Alternatively, automated machine-learning techniques (e.g., AutoML, Auto-sklearn) integrating multiple techniques such as model selection, hyperparameter tuning, and cross-validation may be leveraged to automate the entire process of parameter-tuning 416.

In some examples of the retraining phase 410, model interpretation techniques 418 may be integrated to understand how the seed models 402 make its predictions, thus diagnosing potential issues and enabling transparency in decision-making. For model interpretation 418, particularly in regression models 104, a residual analysis may be performed, where a residual represents a difference between a predicted value and an actual value of the target variable. By analyzing these residuals, it may be assessed whether the seed models 402 are making systematic errors, which may point to further adjustments. For example, if the residuals display patterns (such as non-random distribution), it may suggest that the retrained seed models have not captured some underlying relationship in the data, and further feature engineering or model tuning is needed.

Alternatively, model interpretation 418 may involve calculating a feature importance for identifying which input features contribute effectively to the prediction by the classification and regression models. For example, in tree-based models such as decision trees or random forests, feature importance may be computed based on how much each feature reduces the impurity (e.g., Gini index or entropy in classification, or variance in regression) across all decision splits. In some other examples, the importance of a feature may be calculated by measuring the change in model performance (e.g., accuracy or MCC for classification, MSE or MAPE for regression) when the values of feature are randomly shuffled. A large drop in performance may indicate that the feature is important for the predictions by the models.

Additionally, custom training data 414 provided by the customer to fine-tune the seed models 402 may be small or include limited variations of the training examples. To address this limitation, data augmentation 420 may be employed to artificially expand the dataset by generating new, modified versions of the existing examples. For instance, in image-based tasks, common augmentation techniques may include random rotations, flipping, zooming, shifting, and altering brightness or contrast. These transformations may help introduce diversity to the training data, enabling the seed models 402 to learn more robust features and avoid overfitting them to the small dataset during retraining. Similarly, in text or audio tasks, techniques such as paraphrasing, back-translation, random word substitutions, or applying noise may be used to augment the dataset. Other data augmentation techniques may include synthetic data generation using techniques such as SMOTE (synthetic minority over-sampling technique) to balance class distribution, and injecting noise, where small, realistic variations may be added to numerical features such as project timelines or budgets to simulate real-world uncertainties.

Additionally, feature transformation methods, such as scaling or normalization, may also be used to enable model generalization to different ranges of input data. Alternatively, generative models such as variational autoencoders or generative adversarial networks (GANs) may be used to generate new examples from the existing custom training data 414, further expanding the dataset by creating realistic, synthetic samples that resemble the original data. This approach can be particularly useful when dealing with highly imbalanced datasets or when the custom training data 414 lacks sufficient variability. The synthetic examples generated by these generative models may help the model generalize better, improving its performance and robustness, particularly in retraining phase 410 to fine-tune the seed models during retraining 412 on a limited or imbalanced dataset.

DDB 110 may be adjusted automatically during the retraining phase 410 in a similar manner to inference. The automatic adjustment in DDB 110 may include updating the decision boundary based on evaluation metrics or unified performance metric. The retraining phase 410 may involve iteratively evaluating each configuration of the retrained sequential model, consequent to parameter-tuning 416, model interpretation 418 and/or DDB adjustments. During each iteration, a version of the retrained or fine-tuned sequential model may be stored in the model buffer 422 for further evaluation using unified performance metric 404, at 406, based on unseen data 408. This iterative process of evaluating and retraining may result in identifying the best combination of the classification model 102 and regression model 104 for the unseen data 408 associated with the customer. Once the seed models 402 are retrained, inferences on new data 406 or unseen data 408 may be performed by retrieving the (updated) retrained sequential model from the model buffer 422.

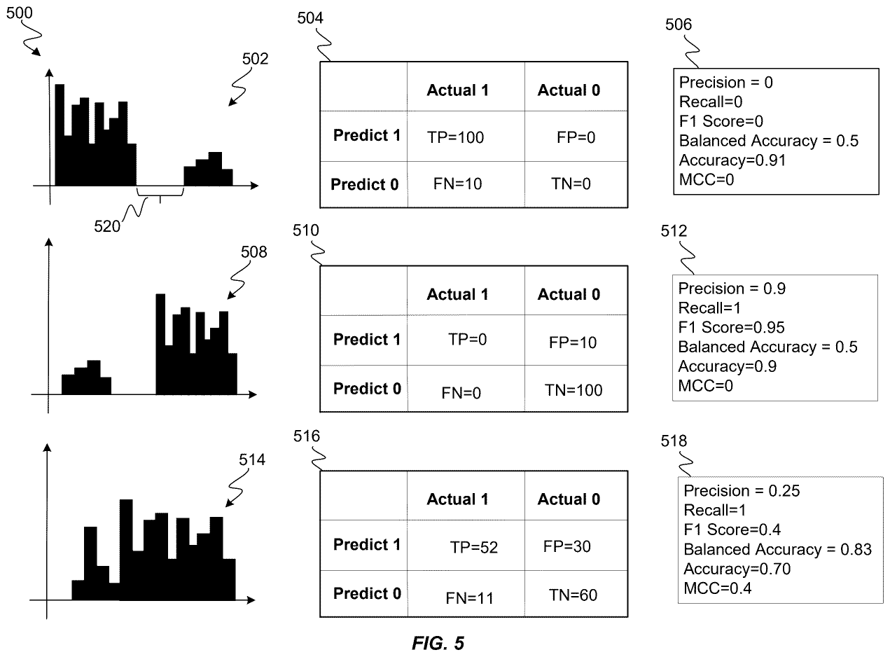

FIG. 5 illustrates an impact of an imbalanced dataset on one or more evaluation metrics associated with the classification model. In some aspects of the present disclosure, Matthews correlation coefficient (MCC) is selected as an evaluation metric for classification. The FIG. 5 shows an illustrative example highlighting why MCC may be a reliable metric for assessing unified performance (404). A histogram 502 of the dataset 106 shows the distribution of a discrete variable (e.g., age, weight) on the x-axis, with a count of each value on the y-axis. In an imbalanced dataset, one class may be underrepresented, resulting in positive or negative imbalance. For instance, in a negatively imbalanced dataset, one class (e.g., age groups under 50) may be overrepresented compared to another class (e.g., age groups over 60). This imbalance is visible in the histogram 502 and can be analyzed before determining the unified performance metric 404. In this imbalanced dataset, a significant gap 520 between classes is apparent, with the majority class dominating. A confusion matrix 504 may reveal this imbalance, showing that the model predicts more instances of the majority class than the minority class. The evaluation metrics 506, derived from this confusion matrix 504, such as precision, recall, F1 score, and MCC, may reflect the effects of the imbalance.

For a positively imbalanced dataset, the histogram 508 shows an opposite trend, with the minority and majority classes swapped. In this example, the confusion matrix 510 may show more true negatives than true positives, reflecting the imbalanced nature of the dataset. Evaluation metrics 512 calculated from the confusion matrix 510 may also exhibit different values compared to the negatively imbalanced or balanced dataset. The balanced dataset, represented by histogram 514, shows an even distribution between classes, leading to a confusion matrix 516 with near-equal true positives and true negatives. Evaluation metrics 518 reflect this balance with some metrics staying consistent, while others may change. MCC stands out as a robust metric that accounts for the entire confusion matrix, including imbalances. Unlike other metrics (e.g., precision or recall), MCC remains unaffected by the imbalance in individual class distributions, providing a more reliable measure of overall performance. In balanced datasets, MCC typically returns a non-zero value, highlighting its utility even when the dataset is imbalanced.

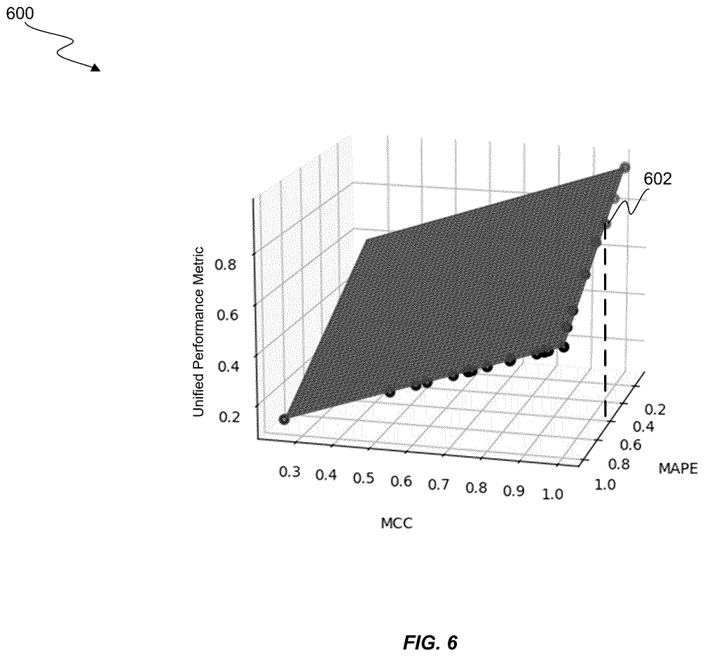

FIG. 6 shows an illustrative example of a unified performance metric 404 for assessing performance of a machine-learning pipeline 100 involving a machine-learning pipeline, comprising a classification model 102 configured in parallel with a regression model 104. The penalizing factors and the contributions of these models are set to 1. The FIG. 6 shows a three-dimensional (3D) plot 600 depicting a relationship between a classification performance metric, a regression performance metric and the unified performance metric 404 that combines these two metrics into a single evaluation metric. To evaluate the relationship, Mathews correlation coefficient (MCC) representing classification performance is drawn on horizontal axis (x-axis) and absolute percentage error (MAPE) representing regression performance is drawn on vertical axis (y-axis). The 3D plot 600 demonstrates how the unified performance metric, as disclosed herein, effectively captures performance of the ML pipeline 100 across two domains.

The 3D plot 600 exhibits a linear relationship between MCC, MAPE and the unified performance metric 404, as evident by the flat planar surface. The linear relationship signifies that as MCC increases, indicating improved classification accuracy and MAPE decreases, indicating better regression performance, the unified performance metric 404 also increases. For example, when classification accuracy is strong with an MCC value of 1, but with an error in regression performance with a MAPE value of 0.4, the corresponding unified performance metric is approximately 0.82, at 602. This value of unified performance metric effectively highlights the error in regression, despite the perfect classification accuracy of 1.

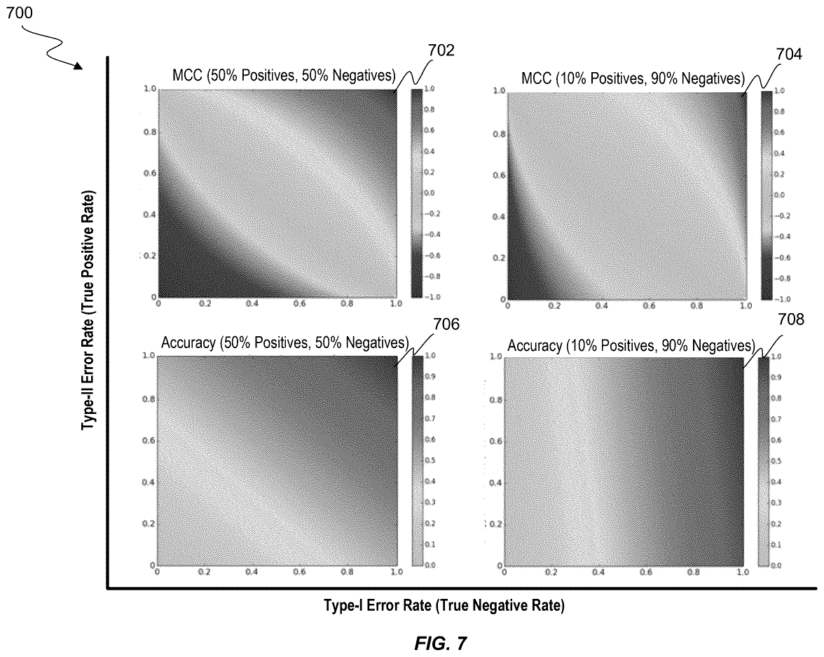

FIG. 7 illustrates a set of heatmaps 700 representing MCC and accuracy under varying conditions of class distributions and different error rates. The set of heatmaps 700 shows a comparison between two classification metrics, i.e., MCC and accuracy under the varying conditions. Each heatmap of the set of heatmaps 700 plots a specific classification metric as a function of Type-1 Error rate (or true negative rate) and Type-II error rate (true positive rate), enabling a detailed exploration of how these error rates impact the performance metrics. The top row including heatmaps 702 and 704 visualizes MCC, while the bottom row including heatmaps 706 and 708 focuses on accuracy. Additionally, the left column corresponds to a balanced dataset (i.e., 50% positives and 50% negatives), while the right column corresponds to an imbalanced dataset (i.e., 10% positives and 90% negatives).

It may be understood from the FIG. 7 that the x-axis representing Type-I error is drawn such that a value of 1 on this axis indicates zero false positive rate or perfect true negative rate. Similarly, a value of 0 on x-axis indicates maximum false positives representing zero true negatives. Additionally, for y-axis representing Type-II error is drawn such that a value of 1 indicates zero false negatives or perfect true positive rate, while 0 indicates maximum false negative representing no true positive. With this context, the heatmaps 702 and 704 depict MCC for the balanced and imbalanced datasets respectively, indicating that MCC is highly sensitive to both error rates, achieving its maximum value (close to 1) when both error rates are minimal (towards top right corner of heatmaps 702 and 704). As the error rate increases, MCC degrades towards a diagonal symmetrically for the balanced dataset while asymmetrically for imbalanced dataset.

Conversely, for heatmaps 706 and 708, accuracy remains high even in regions with higher type-II errors for imbalanced datasets, highlighting its limitation in handling class imbalance effectively. In heatmaps 702 and 706 with balanced dataset, both classification metrics accuracy and MCC show more uniform degradation along the diagonal, indicating sensitivity to equal contributions of false positives and false negatives. However, in imbalanced datasets associated with heatmaps 704 and 708, MCC demonstrates robustness by penalizing errors more appropriately, while accuracy tends to remain misleadingly high due to dominance by the majority class. The set of heatmaps 700 highlights preference of classification metric MCC over accuracy for evaluating classification models, particularly for imbalanced datasets.

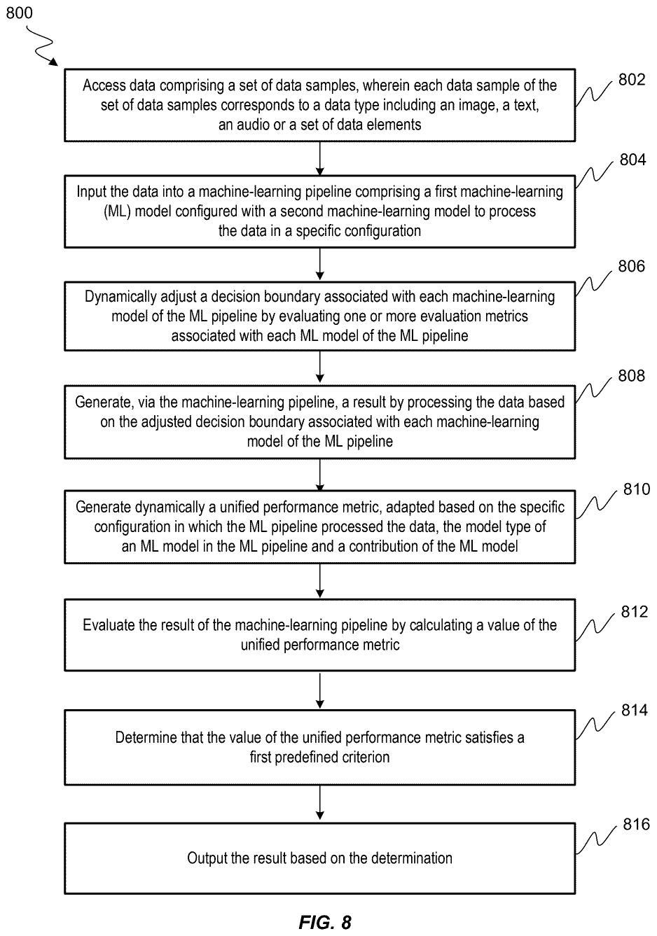

FIG. 8 illustrates an exemplary workflow 800 for a dynamic and unified performance evaluation of the machine-learning pipeline in accordance with certain aspects of the present disclosure. The blocks in workflow 800 are illustrated in a specific order, while the order can be modified, for example, some blocks may be performed before others, and some blocks may be performed simultaneously. The blocks can be performed by hardware, software, or a combination thereof. The disclosed techniques may involve dynamic performance evaluation in machine learning (ML) pipelines, where a unified performance metric adapts to different model types and configurations. At block 802, data may be accessed comprising a set of data samples, where each data sample of the set of data samples corresponds to one or more data types including an image, a text, an audio and a set of data elements (e.g., quantitative measurements, an observation including structured data elements, or continuous data). At block 804, the data may be fed for inference to a ML pipeline 100 that may include a first machine-learning model configured with a second machine-learning model to process the data in a specific configuration e.g., (series or parallel). Each ML model in the ML pipeline 100 may be associated with a model type that corresponds to a classification model 102, a regression model 104, or a combination thereof.

Although the techniques discussed in the current disclosure include the ML pipeline with the pair of ML models, however, a combination of more than two machine-learning models may also be configured e.g., in a series or parallel manner. In some aspects, the first and the second machine-learning models may be pre-trained models e.g., a transfer-learning based model, thereby enabling time efficiency and lower operational costs. At block 806, decision boundaries of each ML model may be adjusted based on one or more evaluation metrics associated with each ML model of the ML pipeline 100. In some aspects of the current disclosure, the decision boundary may be manually or dynamically adjusted. Adjusting the decision boundary manually may be a time consuming and inefficient method, as it may trigger an iterative or hit-and-trial method, by the user, to train the pair of ML models. Whereas, dynamically adjusting the decision boundary may incorporate techniques e.g., calibrating the output probabilities generated by each ML model in the ML pipeline using regression-based techniques.

Once the decision boundary is adjusted, the result may be generated by the ML pipeline by processing the input data, at block 808. At block 810, a unified performance metric 404 may be generated dynamically. This metric may be adapted based on the specific configuration in which the machine-learning pipeline 100 processed the data, the model type of a machine-learning model in the machine-learning pipeline 100 and a contribution of the machine-learning model in the machine-learning pipeline 100. The generated result may be evaluated, at block 812, by calculating a value of the unified performance metric 404 that evaluates the ML pipeline 100 as described by the techniques of the current disclosure. In some aspects of the disclosure, the unified performance metric may be assessed against a first predefined criterion e.g., by determining that the value of the unified performance metric 404 satisfies an acceptable threshold, at block 814. In some examples, the unified performance metric may be defined in a range e.g., −1 to 1 or 0 to 1, where a minimum value of the range may correspond to a degraded performance of the ML pipeline while a maximum value of the range may correspond to a perfect prediction. At block 816, based on this determination the result generated by the ML pipeline 100 may be output.

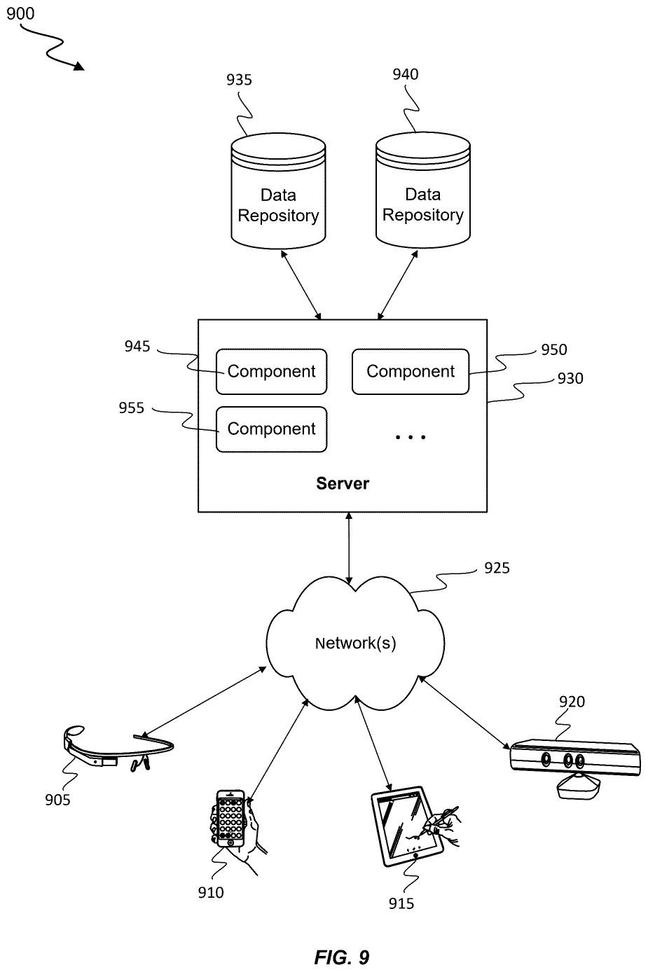

FIG. 9 depicts a simplified diagram of a distributed system 900 through which user inputs may be provided in accordance with some aspects of the present disclosure. In the illustrated disclosure, distributed system 900 may include one or more client computing devices 905, 910, 915, and 920, coupled to a server 930 via one or more network(s) 925. Client computing devices 905, 910, 915, and 920 may comprise one or more computer systems and may be configured to execute one or more applications that perform dynamic and uniform evaluation of the ML pipeline in accordance with the disclosed techniques. In various aspects, server 930 may be adapted to run one or services or software applications that enable techniques for implementing the ML pipeline 100. In certain aspects, server 930 may also provide other services or software applications that may include non-virtual and virtual environments. In some respects, these services may be offered as web-based or cloud services, such as under a Software as a Service (SaaS) model to the users of client computing devices 905, 910, 915, or 920. Users operating client computing devices 905, 910, 915, or 920 may, in turn, utilize one or more subject applications to interact with server 930. Furthermore, client computing devices 905, 910, 915, or 920 may, in turn, utilize one or more subject applications to provide entity names to be assigned in the hierarchical structure.

In the configuration depicted in FIG. 9, server 930 may include one or more components 945, 950, and 955 that implement the functions performed by server 930. These components may include software components that may be executed by one or more processors, hardware components, or combinations thereof. It may be appreciated that various system configurations are possible, which may be different from distributed system 900. The embodiment shown in FIG. 9 is thus one example of a distributed system for implementing an embodiment system and is not intended to be limiting. Users may use client computing devices 905, 910, 915, or 920 for providing user input according to the teachings of this disclosure. A computing device may provide an interface that enables a user to interact with the computing device. The computing device may also output information to the user via this interface. Although FIG. 9 depicts only four client computing devices, any number of client computing devices may be supported.

The client computing devices may include various types of computing systems such as portable handheld devices, general purpose computers such as personal computers and laptops, workstation computers, wearable devices, gaming systems, thin subjects, various messaging devices, sensors or other sensing devices, and the like. These client computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head-mounted displays and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The subject devices may be capable of executing various applications such as various Internet-related applications and communication applications (e.g., E-mail applications, short message service (SMS) applications) and may use various communication protocols.

Network(s) 925 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 925 may be a Local Area Network (LAN), network based on Ethernet, Token-Ring, a Wide-Area Network (WAN), the Internet, a virtual network, a Virtual Private Network (VPN), an intranet, an extranet, a Public Switched Telephone Network (PSTN), an infra-red network, a wireless network (e.g., a network operating under any of the Institute of Electrical and Electronics (IEEE) 1002.11 suite of protocols, Bluetooth®, or any other wireless protocol), or any combination of these or other networks.

Server 930 may include one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 930 may include one or more virtual machines running virtual operating systems, or other computing architectures involving virtualization such as one or more flexible pools of logical storage devices that may be virtualized to maintain virtual storage devices for the server. In various aspects, server 930 may be adapted to run one or more services or software applications that provide the functionality described in the foregoing disclosure.

The computing systems of server 930 may run one or more operating systems including any of those discussed above, as well as any commercially available server operating system. Server 930 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation, those commercially available from Oracle®, Microsoft®, Sybase®, IBM® (International Business Machines), and the like.

In some implementations, server 930 may include one or more applications to implement various aspects of the disclosure to auto-assign entity names provided by the user through various client computing devices e.g., 905 to 920. The dataset 106 of FIG. 1 may include data of various forms such as text data, an image, or combination of text and images. As an example, the data may be text or image that may include but are not limited to, Twitter® feeds, Facebook® updates, or real-time updates received from one or more third-party information sources and continuous data streams, which may include real-time events related to sensor data applications, financial tickers, network performance measuring tools (e.g., network monitoring and traffic management applications), clickstream analysis tools, automobile traffic monitoring, and the like. Server 930 may also include one or more applications to display the output of various processes of computer-implemented method via one or more display devices of client computing devices 905, 910, 915, and 920.

Distributed system 900 may also include one or more databases 935 and 940. These databases may be used to store data and other information in certain aspects. Databases 935, and 940 may reside in a variety of locations. For example, a data repository used by server 930 may be local to server 930 or may be remote from server 930 and in communication with server 930 via a network-based or dedicated connection. Databases 935, and 940 may be of different types. In certain aspects, a data repository used by server 930 may be a database, for example, a relational database, such as databases provided by Oracle Corporation® and other vendors. One or more of these databases may be adapted to enable storage, update, and retrieval of data to and from the database in response to Structured Query Language (SQL) formatted commands.

In certain aspects, one or more databases 935, and 940 may also be used by applications to store application data. The databases used by applications may be of different types such as, for example, a key-value store repository, an object store repository, or a general storage repository supported by a file system. In certain aspects, the techniques for implementing the ML pipeline 100 may be offered as services via a cloud environment.

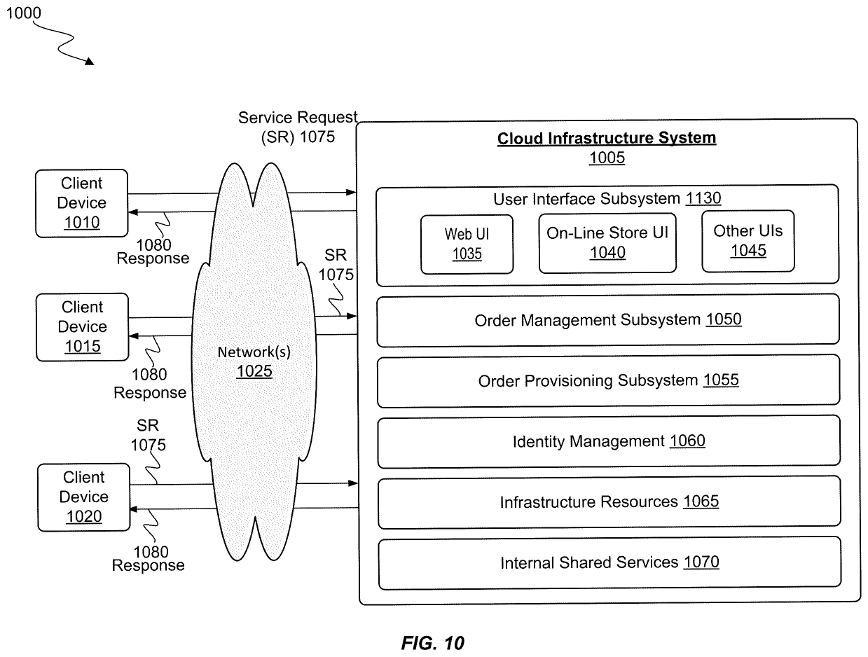

The embodiment depicted in FIG. 10 is only one example of a cloud infrastructure system and is not intended to be limiting. It should be appreciated that, in some other respects, cloud infrastructure system 1005 may have more or fewer components than those depicted in FIG. 10, may combine two or more components, or may have a different configuration or arrangement of components. For example, although FIG. 10 depicts three client computing devices, any number of client computing devices may be supported in alternative aspects. The term cloud service is generally used to refer to a service that is made available to users on demand and via a communication network such as the Internet by systems (e.g., cloud infrastructure system 1005) of a service provider. Typically, in a public cloud environment, servers and systems that make up the cloud service provider's system may be different from the subject's own on-premises servers and systems. The cloud service provider's systems are managed by the cloud service provider. Subjects may thus avail themselves of cloud services provided by a cloud service provider without having to purchase separate licenses, support, or hardware and software resources for the services. For example, a cloud service provider's system may host an application, and a user may, via a network 1025 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 1005 may provide one or more cloud services using different models such as under a Software as a Service (SaaS) model, a Platform as a Service (PaaS) model, an Infrastructure as a Service (IaaS) model, and others, including hybrid service models. Cloud infrastructure system 1005 may include a suite of applications, middleware, databases, or other resources that enable the provision of the various cloud services.

A SaaS model enables an application or software to be delivered to a subject over a communication network like the Internet, as a service, without the subject having to buy the hardware or software for the underlying application. For example, a SaaS model may be used to provide subjects access to on-demand applications that are hosted by cloud infrastructure system 1005. Examples of SaaS services provided by Oracle Corporation® include, without limitation, various services for human resources/capital management, subject relationship management (CRM), enterprise resource planning (ERP), supply chain management (SCM), enterprise performance management (EPM), analytics services, social applications, and others. An IaaS model is generally used to provide infrastructure resources (e.g., servers, storage, hardware, and networking resources) to a subject as a cloud service to provide elastic compute and storage capabilities. Various IaaS services are provided by Oracle Corporation®.

A PaaS model is generally used to provide, as a service, platform, and environment resources that enable subjects to develop, run, and manage applications and services without the subject having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others. Cloud services are generally provided on an on-demand self-service basis, subscription-based, elastically scalable, reliable, highly available, and secure manner. For example, a subject, via a subscription order, may order one or more services provided by cloud infrastructure system 1005. Cloud infrastructure system 1005 may perform processing to provide the services requested in the subject's subscription order. Cloud infrastructure system 1005 may be configured to provide one or even multiple cloud services.

Cloud infrastructure system 1005 may provide cloud services via different deployment models. In a public cloud model, cloud infrastructure system 1005 may be owned by a third-party cloud services provider and the cloud services are offered to any general public subject, where the subject may be an individual or an enterprise. In certain other aspects, under a private cloud model, cloud infrastructure system 1005 may be operated within an organization (e.g., within an enterprise organization) and services provided to subjects that are within the organization. For example, the subjects may be various departments of an enterprise, such as the Human Resources department, the payroll department, etc. or even individuals within the enterprise. In certain other aspects, under a community cloud model, the cloud infrastructure system 1005 and the services provided may be shared by several organizations in a related community. Various other models, such as hybrids of the above-mentioned models may also be used.

Client computing devices 1010, 1015, and 1020 may be of several types (such as 905, 910, 915, and 900 depicted in FIG. 9) and may be capable of operating one or more user applications. A user may use a computing device to interact with cloud infrastructure system 1005, such as to request a service provided by cloud infrastructure system 1005. As depicted in the embodiment in FIG. 10, cloud infrastructure system 1005 may include infrastructure resources 1065 that may be utilized for facilitating the provision of various cloud services offered by cloud infrastructure system 1005. Infrastructure resources 1065 may include, for example, processing resources, storage or memory resources, networking resources, and the like.

In certain aspects, to facilitate efficient provisioning of these resources for supporting the various cloud services provided by cloud infrastructure system 1005 for different subjects, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1005 may itself internally shared services 1070 that are shared by different components of cloud infrastructure system 1005 and which facilitate the provisioning of services by cloud infrastructure system 1005. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1005 may comprise multiple subsystems. These subsystems may be implemented in software, or hardware, or combinations thereof. As depicted in FIG. 10, the subsystems may include a user interface subsystem 1030 that enables users or subjects of cloud infrastructure system 1005 to interact with cloud infrastructure system 1005. User interface subsystem 1030 may include various interfaces such as a web interface 1035, an online store interface 1040 where cloud services provided by cloud infrastructure system 1005 are advertised and are purchasable by a consumer, and other interfaces 1045. For example, a subject may, using a computing device e.g., 905, request (service request 1075) one or more services provided by cloud infrastructure system 1005 using one or more of interfaces 1035, 1040, and 1045. For example, a subject may access the online store, browse cloud services offered by cloud infrastructure system 1005, and place a subscription order for one or more services offered by cloud infrastructure system 1005 that the subject wishes to subscribe to. The service request may include information identifying the subject and one or more services that the subject desires to subscribe to. For example, a subject may place a subscription order for a Chabot related service offered by cloud infrastructure system 1005. As part of the order, the subject may provide information identifying for input (e.g., utterances).

In certain aspects, such as the embodiment depicted in FIG. 10, cloud infrastructure system 1005 may comprise an order management subsystem (OMS) 1050 that is configured to process the new order. Once properly validated, OMS 1050 may invoke order provisioning subsystem (OPS) 1055 that is configured to provision resources for the order including processing, memory, and networking resources. The provisioning may include allocating resources for the order and configuring the resources to facilitate the service requested by the subject order. The manner in which resources are provisioned for an order and the type of the provisioned resources may depend upon the type of cloud service that has been ordered by the subject. For example, according to one workflow, OPS 1055 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting subject for providing the requested service.

Cloud infrastructure system 1005 may send a response or notification 1090 to the requesting subject to indicate when the requested service is now ready for use. In some instances, information (e.g., a link) may be sent to the subject that enables the subject to start using and availing the benefits of the requested services. Cloud infrastructure system 1005 may provide services to multiple subjects. For each subject, cloud infrastructure system 1005 is responsible for managing information related to one or more subscription orders received from the subject, maintaining subject data related to the orders, and providing the requested services to the subject. Cloud infrastructure system 1005 may also collect usage statistics regarding a subject's use of subscribed services. For example, statistics may be collected for the amount of storage used, the amount of data transferred, the number of users, and the amount of system up time and system down time, and the like.

Cloud infrastructure system 1005 may provide services to multiple subjects in parallel. Cloud infrastructure system 1005 may store information for these subjects, including possibly proprietary information. In certain aspects, cloud infrastructure system 1005 comprises an identity management subsystem. Identity management subsystem (IMS) 1060 may be configured to manage the subject's information and provide the separation of the managed information such that information related to one subject is not accessible by another subject. IMS 1060 may be configured to provide various security-related services such as identity services, such as information access management, authentication and authorization services, services for managing subject identities and roles and related capabilities, and the like. Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described aspects may be used individually or jointly.

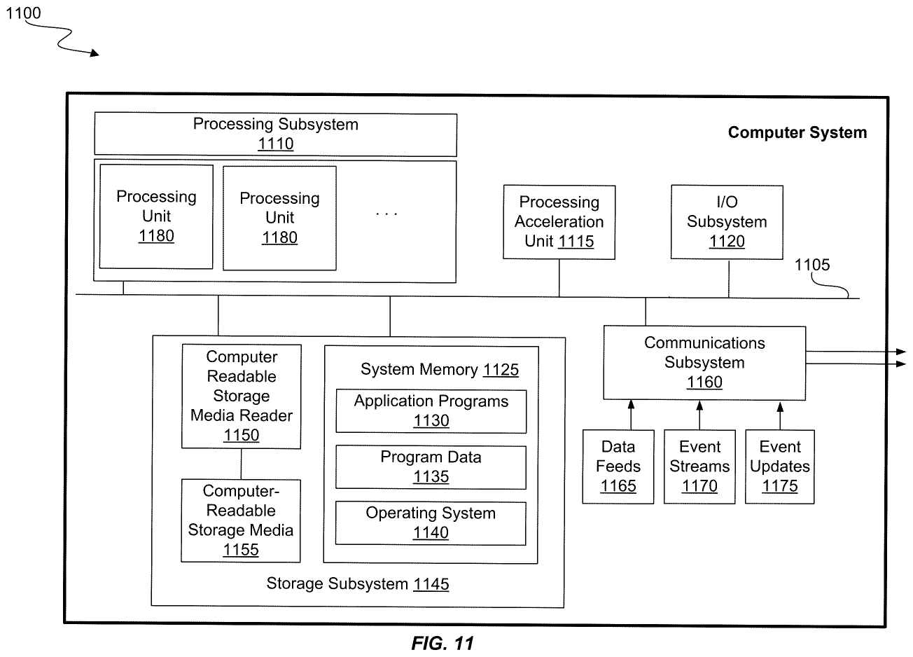

FIG. 11 illustrates an exemplary computer system 1100 that may be used to implement certain aspects of the disclosed techniques for auto-assignment of new entities. As shown in FIG. 11, computer system 1100 includes various subsystems including a processing subsystem 1110 that communicates with a few other subsystems via a bus subsystem 1105. These other subsystems may include a processing acceleration unit 1115, and I/O subsystem 1120, a storage subsystem 1145, and a communications subsystem 1160. Storage subsystem 1145 may include non-transitory computer-readable storage media including storage media 1155 and a system memory 1125.

Bus subsystem 1105 provides a mechanism for letting the various components and subsystems of computer system 1100 communicate with each other as intended. Although bus subsystem 1105 is shown schematically as a single bus, alternative aspects of the bus subsystem may utilize multiple buses. Bus subsystem 1105 may be any of several types of bus structures including a memory bus or memory controller, a peripheral bus, a local bus using any of a variety of bus architectures, and the like. For example, such architectures may include an Industry Standard Architecture (ISA) bus, a Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P13127.1 standard, and the like.

Processing subsystem 1110 controls the operation of computer system 1100 and may comprise one or more processors, Application Specific Integrated Circuits (ASICs), or Field Programmable Gate Arrays (FPGAs). The processors may include single-core, or multicore processors. The processing resources of computer system 1100 may be organized into one or more processing units 1190, 1180, etc. A processing unit may include one or more processors, one or more cores from the same or different processors, a combination of cores and processors, or other combinations of cores and processors. In some embodiments, processing subsystem 1110 may include one or more special-purpose co-processors such as graphics processors, digital signal processors (DSPs), or the like. In some embodiments, some, or all of the processing units of processing subsystem 1110 may be implemented using customized circuits, such as ASICs, or FPGAs.

In some embodiments, the processing units in processing subsystem 1110 may execute instructions stored in system memory 1125 or on computer-readable storage media 1155. In various aspects, the processing units may execute a variety of programs or code instructions and may maintain multiple concurrently executing programs or processes. At any given time, some, or all of the program code to be executed may be resident in system memory 1125 and/or on computer-readable storage media 1155 including potentially on one or more storage devices. Through suitable programming, processing subsystem 1110 may provide various functionalities described above. In instances where computer system 1100 is executing one or more virtual machines, one or more processing units may be allocated to each virtual machine. In certain aspects, a processing acceleration unit 1115 may optionally be provided for performing customized processing or for off-loading some of the processing performed by processing subsystem 1110 to accelerate the overall processing performed by computer system 1100.

I/O subsystem 1120 may include devices and mechanisms for inputting information to computer system 1100 and/or for outputting information from or via computer system 1100. In general, use of the term input device is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 370 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1100 to a user or other computer. User interface output devices may include a display subsystem, indicator lights, or non-visual displays such as audio output devices, etc. The display subsystem may be a Cathode Ray Tube (CRT), a flat-panel device, such as that using a Liquid Crystal Display (LCD) or plasma display, a projection device, a touch screen, and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 1145 provides a repository or data store for storing information and data that is used by computer system 1100. Storage subsystem 1145 provides a tangible non-transitory computer-readable storage medium for storing the basic programming and data constructs that provide the functionality of some aspects. Storage subsystem 1145 may store software (e.g., programs, code modules, instructions) that, when executed by processing subsystem 1110 provides the functionality described above. The software may be executed by one or more processing units of processing subsystem 1110. Storage subsystem 1145 may also provide a repository for storing data used in accordance with the teachings of this disclosure.

Storage subsystem 1145 may include one or more non-transitory memory devices, including volatile and non-volatile memory devices. As shown in FIG. 11, storage subsystem 1145 includes a system memory 1125 and a computer-readable storage media 1155. System memory 1125 may include a number of memories including a volatile main random-access memory (RAM) for storage of instructions and data during program execution and a non-volatile Read Only Memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1110. In some implementations, system memory 1125 may include multiple different types of memory, such as Static Random Access Memory (SRAM), Dynamic Random Access Memory (DRAM), and the like.

By way of example, and not limitation, as depicted in FIG. 11, system memory 1125 may load application programs 1130 that are being executed, which may include various applications such as Web browsers, mid-tier applications, Relational Database Management Systems (RDBMS), etc., program data 1135, and an operating system 1140. By way of example, operating system 1140 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1155 may store programming and data constructs that provide the functionality of some aspects. Computer-readable media 1155 may provide storage of computer-readable instructions, data structures, program modules, and other data for computer system 1100. Software (programs, code modules, instructions) that, when executed by processing subsystem 1110 provides the functionality described above, may be stored in storage subsystem 1145. By way of example, computer-readable storage media 1155 may include non-volatile memory such as a hard disk drive, a magnetic disk drive, an optical disk drive such as a CD ROM, Digital Video Disc (DVD), a Blu-Ray® disk, or other optical media. Computer-readable storage media 1155 may include, but is not limited to, Zip® drives, flash memory cards, Universal Serial Bus (USB) flash drives, secure digital (SD) cards, DVD disks, digital video tape, and the like. Computer-readable storage media 1155 may also include, Solid-State Drives (SSD) based on non-volatile memory such as flash-memory based SSDs, enterprise flash drives, solid state ROM, and the like, SSDs based on volatile memory such as solid state RAM, dynamic RAM, static RAM, Dynamic Random Access Memory (DRAM)-based SSDs, magneto resistive RAM (MRAM) SSDs, and hybrid SSDs that use a combination of DRAM and flash memory based SSDs.

In certain aspects, storage subsystem 1145 may also include a computer-readable storage media reader 1150 that may further be connected to computer-readable storage media 1155. Reader 1150 may receive and be configured to read data from a memory device such as a disk, a flash drive, etc.

In certain aspects, Computer System 1100 may support virtualization technologies, including but not limited to the virtualization of processing and memory resources. For example, computer system 1100 may provide support for executing one or more virtual machines. In certain aspects, Computer System 1100 may execute a program such as a hypervisor that facilitates the configuring and managing of the virtual machines. Each virtual machine may be allocated memory, computer (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1100. Accordingly, multiple operating systems may potentially be run concurrently by Computer System 1100.

Communications subsystem 1160 provides an interface to other computer systems and networks. Communications subsystem 1160 serves as an interface for receiving data from and transmitting data to other systems from computer system 1100. For example, communications subsystem 1160 may enable computer system 1100 to establish a communication channel to one or more subject devices via the Internet for receiving and sending information from and to the subject devices. For example, the communication subsystem may be used to transmit a response to a user regarding the inquiry for a Chabot.

Communication subsystem 1160 may support both wired and/or wireless communication protocols. For example, in certain aspects, communications subsystem 1160 may include Radio Frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 1202.XX family standards, or other mobile communication technologies, or any combination thereof), Global Positioning System (GPS) receiver components, and/or other components. In some aspects communications subsystem 1160 may provide wired network connectivity (e.g., Ethernet) in addition to or instead of a wireless interface.

Communication subsystem 1160 may receive and transmit data in various forms. For example, in some embodiments, in addition to other forms, communications subsystem 1160 may receive input communications in the form of structured and/or unstructured data feeds 1165, event streams 1170, event updates 1175, and the like. For example, communications subsystem 1160 may be configured to receive (or send) data feeds 1165 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1160 may be configured to receive data in the form of continuous data streams, which may include event streams 1170 of real-time events and/or event updates 1175, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1160 may also be configured to communicate data from computer system 1100 to other computer systems or networks. The data may be communicated in various forms such as structured and/or unstructured data feeds 1165, event streams 1170, event updates 1175, and the like to one or more databases that may be in communication with one or more streaming data source computers coupled to computer system 1100.

Computer system 1100 may be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in art may appreciate other ways and/or methods to implement the various aspects.

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described aspects may be used individually or jointly.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

1. A computer-implemented method including:
accessing data comprising a set of data samples, wherein each data sample of the set of data samples corresponds to one or more data types including an image, a text, an audio and a set of data elements;
inputting the data into a machine-learning pipeline comprising a first machine-learning model configured with a second machine-learning model to process the data in a specific configuration, wherein a model type associated with each machine-learning model of the machine-learning pipeline corresponds to a classification model and/or a regression model;
dynamically adjusting a decision boundary associated with each machine-learning model of the machine-learning pipeline by evaluating one or more evaluation metrics associated with each machine-learning model of the machine-learning pipeline;
generating, via the machine-learning pipeline, a result by processing the data based on the adjusted decision boundary associated with each machine-learning model of the machine-learning pipeline;
generating dynamically a unified performance metric that is adapted based on the specific configuration, the model type of each machine-learning model of the machine-learning pipeline and a contribution of each machine-learning model of the machine-learning pipeline;
evaluating the result of the machine-learning pipeline by calculating a value of the unified performance metric;
determining that the value of the unified performance metric satisfies a first predefined criterion; and
outputting the result based on the determination.

2. The computer-implemented method of claim 1, further including:
iteratively triggering, based on another determination that the value of the unified performance metric satisfies a second predefined criterion, retraining of the machine-learning pipeline generating another result for which the unified performance metric satisfies the first predefined criterion, wherein the retraining includes:
accessing custom training data comprising another set of data samples, wherein each data sample of the other set of data samples corresponds to the one or more data types that are similar to the one or more data types associated with the data;
performing a parameter tuning of the machine-learning pipeline by modeling the unified performance metric as a probabilistic function to search a combination of one or more hyperparameters from a set of hyperparameters that improves the unified performance metric based on the custom training data, wherein each hyperparameter of the set of hyperparameters is assigned a set of values;
storing the machine-learning pipeline to a model buffer;
generating, based on the data, the other result by the machine-learning pipeline;
and
evaluating the other result that is stored in the model buffer by calculating the unified performance metric.

3. The computer-implemented method of claim 2, further including:
generating a new result by the machine-learning pipeline that is retrained by inputting new data.

4. The computer-implemented method of claim 2, wherein the retraining further includes:
augmenting the custom training data by applying one or more processing techniques based on the one or more data types of the custom training data.

5. The computer-implemented method of claim 1, wherein the decision boundary associated with each machine-learning model in the machine-learning pipeline is dynamically adjusted by automatically calibrating predicted outputs that are generated by each machine-learning model of the machine-learning pipeline using a regression technique.

6. The computer-implemented method of claim 1, wherein the unified performance metric includes a statistical weighted average of a first evaluation metric associated with a first machine-learning model and a second evaluation metric associated with a second machine-learning model, and wherein a weight associated with each evaluation metric of the unified performance metric corresponds to a product of a penalty factor and a contribution of each associated machine-learning model of the machine-learning pipeline.

7. The computer-implemented method of claim 6, wherein the first machine-learning model is the classification model, a second machine-learning model is the regression model, the first evaluation metric is a normalized Mathews correlation coefficient (MCC), and the second evaluation metric is a normalized mean absolute percentage error (MAPE).

8. A system comprising:
one or more data processors; and
a non-transitory computer readable storage medium containing instruction which, when executed on the one or more data processors, cause the one or more data processors to perform a set of operations including:
accessing data comprising a set of data samples, wherein each data sample of the set of data samples corresponds to one or more data types including an image, a text, an audio and a set of data elements;
inputting the data into a machine-learning pipeline comprising a first machine-learning model configured with a second machine-learning model to process the data in a specific configuration, wherein a model type associated with each machine-learning model of the machine-learning pipeline corresponds to a classification model and/or a regression model;
dynamically adjusting a decision boundary associated with each machine-learning model of the machine-learning pipeline by evaluating one or more evaluation metrics associated with each machine-learning model of the machine-learning pipeline;
generating, via the machine-learning pipeline, a result by processing the data based on the adjusted decision boundary associated with each machine-learning model of the machine-learning pipeline;
generating dynamically a unified performance metric that is adapted based on the specific configuration, the model type of each machine-learning model in the machine-learning pipeline and a contribution of each machine-learning model in the machine-learning pipeline;
evaluating the result of the machine-learning pipeline by calculating a value of the unified performance metric;
determining that the value of the unified performance metric satisfies a first predefined criterion; and
outputting the result based on the determination.

9. The system of claim 8, further including:
iteratively triggering, based on another determination that the value of the unified performance metric satisfies a second predefined criterion, retraining of the machine-learning pipeline generating another result for which the unified performance metric satisfies the first predefined criterion, wherein the retraining includes:
accessing custom training data comprising another set of data samples, wherein each data sample of the other set of data samples corresponds to the one or more data types that are similar to the one or more data types associated with the data;
performing a parameter tuning of the machine-learning pipeline by modeling the unified performance metric as a probabilistic function to search a combination of one or more hyperparameters from a set of hyperparameters that improves the unified performance metric based on the custom training data, wherein each hyperparameter of the set of hyperparameters is assigned a set of values;
storing the machine-learning pipeline to a model buffer;
generating, based on the data, the other result by the machine-learning pipeline; and
evaluating the other result generated by the machine-learning pipeline that is stored in the model buffer by calculating the unified performance metric.

10. The system of claim 9, further including:
generating a new result by the machine-learning pipeline that is retrained by inputting new data.

11. The system of claim 9, wherein the retraining further includes:
augmenting the custom training data by applying one or more processing techniques based on the one or more data types of the custom training data.

12. The system of claim 8, wherein the decision boundary associated with each machine-learning model in the machine-learning pipeline is dynamically adjusted by automatically calibrating predicted outputs that are generated by each machine-learning model of the machine-learning pipeline using a regression technique.

13. The system of claim 8, wherein the unified performance metric includes a statistical weighted average of a first evaluation metric associated with a first machine-learning model and a second evaluation metric associated with a second machine-learning model, and wherein a weight associated with each evaluation metric of the unified performance metric corresponds to a product of a penalty factor and a contribution of each associated machine-learning model of the machine-learning pipeline.

14. The system of claim 13, wherein the first machine-learning model is the classification model, a second machine-learning model is the regression model, the first evaluation metric is a normalized Mathews correlation coefficient (MCC), and the second evaluation metric is a normalized mean absolute percentage error (MAPE).

15. A computer-program product tangibly embodied in a non-transitory machine readable storage medium, including instructions configured to cause one or more data processors to perform to perform a set of operations comprising:
accessing data comprising a set of data samples, wherein each data sample of the set of data samples corresponds to one or more data types including an image, a text, an audio and a set of data elements;
inputting the data into a machine-learning pipeline comprising a first machine-learning model configured with a second machine-learning model to process the data in a specific configuration, wherein a model type associated with each machine-learning model of the machine-learning pipeline corresponds to a classification model and/or a regression model;
dynamically adjusting a decision boundary associated with each machine-learning model of the machine-learning pipeline by evaluating one or more evaluation metrics associated with each machine-learning model of the machine-learning pipeline;
generating, via the machine-learning pipeline, a result by processing the data based on the adjusted decision boundary associated with each machine-learning model of the machine-learning pipeline;
generating dynamically a unified performance metric that is adapted based on the specific configuration, the model type of each machine-learning model in the machine-learning pipeline and a contribution of each machine-learning model in the machine-learning pipeline;
evaluating the result of the machine-learning pipeline by calculating a value of the unified performance metric;
determining that the value of the unified performance metric satisfies a first predefined criterion; and
outputting the result based on the determination.

16. The computer-program product of claim 15, further including:
iteratively triggering, based on another determination that the value of the unified performance metric satisfies a second predefined criterion, retraining of the machine-learning pipeline generating another result for which the unified performance metric satisfies the first predefined criterion, wherein the retraining includes:
accessing custom training data comprising another set of data samples, wherein each data sample of the other set of data samples corresponds to the one or more data types that are similar to the one or more data types associated with the data;
performing a parameter tuning of the machine-learning pipeline by modeling the unified performance metric as a probabilistic function to search a combination of one or more hyperparameters from a set of hyperparameters that improves the unified performance metric based on the custom training data, wherein each hyperparameter of the set of hyperparameters is assigned a set of values;
storing the machine-learning pipeline to a model buffer;
generating, based on the data, the other result by the machine-learning pipeline;
and
evaluating the other result generated by the machine-learning pipeline that is stored in the model buffer by calculating the unified performance metric.

17. The computer-program product of claim 15, further including:
generating a new result by the machine-learning pipeline that is retrained by inputting new data.

18. The computer-program product of claim 16, wherein the retraining further includes:
augmenting the custom training data by applying one or more processing techniques based on the one or more data types of the custom training data.

19. The computer-program product of claim 15, wherein the decision boundary associated with each machine-learning model in the machine-learning pipeline is dynamically adjusted by automatically calibrating predicted outputs that are generated by each machine-learning model of the machine-learning pipeline using a regression technique.

20. The computer-program product of claim 15, wherein the unified performance metric includes a statistical weighted average of a first evaluation metric associated with a first machine-learning model and a second evaluation metric associated with a second machine-learning model, and wherein a weight associated with each evaluation metric of the unified performance metric corresponds to a product of a penalty factor and a contribution of each associated machine-learning model of the machine-learning pipeline.
